(19) United States
(12) Patent Application Publication
(10) Pub. No.: US 2018/0018077 A1
(43) Pub. Date: Jan. 18, 2018

(54) NON-TRANSITORY STORAGE MEDIUM ENCODED WITH COMPUTER READABLE INFORMATION PROCESSING PROGRAM ALLOWING CHANGE TO ORDER OF ARRANGEMENT PREFERRED BY USER WITH SIMPLIFIED SCHEME, INFORMATION PROCESSING APPARATUS, METHOD OF CONTROLLING INFORMATION PROCESSING APPARATUS, AND INFORMATION PROCESSING SYSTEM

(71) Applicant: NINTENDO CO., LTD., Kyoto (JP)

(72) Inventors: Tomoyoshi YAMANE, Kyoto-shi (JP); Takao SHIMIZU, Kyoto-shi (JP)

(21) Appl. No.: 15/408,764

(22) Filed: Jan. 18, 2017

(30) Foreign Application Priority Data
Jul. 12, 2016 (JP) 2016-137808

(51) Int. Cl. G06F 3/0481; G06F 3/0482

(52) U.S. Cl. CPC G06F 3/04817; G06F 3/04812; G06F 3/0482

(57) ABSTRACT

An information processing program executed by a computer of an information processing apparatus connected to a display causes the computer to function as an operation acceptance unit which accepts a prescribed operation, a sort unit which changes an order of arrangement of a plurality of contents in accordance with input of the prescribed operation accepted by the operation acceptance unit, and a representation control unit which has the display show the plurality of contents of which order of arrangement has been changed by the sort unit. The representation control unit has information showing contents of the changed order of arrangement shown for a prescribed period.

This nonprovisional application is based on Japanese Patent Application No. 2016-137808 filed with the Japan Patent Office on Jul. 12, 2016, the entire contents of which are hereby incorporated by reference.

### FIELD

The present disclosure relates to processing for controlling representation on an information processing apparatus.

### BACKGROUND AND SUMMARY

A scheme for changing an order of arrangement of a plurality of objects such as thumbnail images or icons in a screen showing a list of the plurality of objects has conventionally been proposed.

For example, a scheme for moving only an icon pointed with a stick or inserting the icon between two other icons as a user touches a screen with the stick and slides the stick in a perpendicular direction has been disclosed.

With the scheme above, however, an order of arrangement preferred by a user should be set by moving an icon through a slide operation, which has been bothersome.

In order to solve the problem as above, an information processing program which allows change to an order of arrangement preferred by a user with a simplified scheme, an information processing apparatus, a method of controlling an information processing apparatus, and an information processing system are provided.

A non-transitory storage medium encoded with a computer readable information processing program executed by a computer of an information processing apparatus connected to a display according to one aspect, the information processing program causing the computer to function as an operation acceptance unit which accepts a prescribed operation, a sort unit which changes an order of arrangement of a plurality of contents in accordance with input of the prescribed operation accepted by the operation acceptance unit, and a representation control unit which has the display show the plurality of contents of which order of arrangement has been changed by the sort unit. The representation control unit has information shown for a prescribed period, the information showing contents of the changed order of arrangement.

In the exemplary embodiment, the representation control unit has the information showing the contents of the changed order of arrangement unshown after lapse of the prescribed period since the prescribed operation accepted by the operation acceptance unit.

In the exemplary embodiment, the representation control unit has the information showing the contents of the changed order of arrangement shown for the prescribed period as being superimposed on at least some of the plurality of contents.

In the exemplary embodiment, the sort unit sequentially selects a plurality of types of order of arrangement in accordance with input of the prescribed operation accepted by the operation acceptance unit and changes the order of arrangement of the plurality of contents in accordance with the selected order of arrangement.

In the exemplary embodiment, the sort unit selects a first order of arrangement from among the plurality of types of order of arrangement when input of the prescribed operation is accepted by the operation acceptance unit after a last order of arrangement of the plurality of types of order of arrangement is selected.

In the exemplary embodiment, the representation control unit further has the display show a selection cursor with which each of the plurality of contents shown on the display can be selected in accordance with an instruction. The representation control unit has the selection cursor shown in correspondence with a first content of the plurality of contents arranged by the sort unit.

In the exemplary embodiment, the plurality of contents correspond to a plurality of icons in a menu, respectively.

An information processing apparatus connected to a display according to one aspect includes an operation acceptance unit which accepts a prescribed operation, a sort unit which changes an order of arrangement of a plurality of contents in accordance with input of the prescribed operation accepted by the operation acceptance unit, and a representation control unit which has the display show the plurality of contents of which order of arrangement has been changed by the sort unit. The representation control unit has information shown for a prescribed period, the information showing contents of the changed order of arrangement.

A method of controlling an information processing apparatus connected to a display according to one aspect includes accepting a prescribed operation, changing an order of arrangement of a plurality of contents in accordance with input of the accepted prescribed operation, and showing on the display, the plurality of contents of which order of arrangement has been changed. The showing the plurality of contents includes showing information showing contents of the changed order of arrangement for a prescribed period.

An information processing system according to one aspect includes an operation acceptance unit which accepts a prescribed operation, a sort unit which changes an order of arrangement of a plurality of contents in accordance with input of the prescribed operation accepted by the operation acceptance unit, and a representation control unit which has a display unit show the plurality of contents of which order of arrangement has been changed by the sort unit. The representation control unit has information shown for a prescribed period, the information showing contents of the changed order of arrangement.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a schematic block diagram of a configuration of a game device 1 based on a first embodiment.

FIG. 2 is a diagram illustrating a list LS of game programs stored in a memory 30.

FIG. 3 is a diagram illustrating a list of schemes of an order of arrangement.

FIG. 4 is a diagram illustrating a menu screen 100 based on the first embodiment.

FIG. 5 is a diagram illustrating a menu screen 110 after sort processing based on the first embodiment.

FIG. 6 is a diagram illustrating a flow of sort processing in game device 1 based on the first embodiment.

FIG. 7 is a diagram illustrating a concept of transition of a screen in a game device based on a second embodiment.

FIG. 8 is a schematic block diagram of a configuration of a game device 1# based on the second embodiment.

FIG. 9 is a diagram illustrating a menu screen 200 based on the second embodiment.

FIG. 10 is a diagram illustrating a menu screen 210 based on the second embodiment.

FIG. 11 is a diagram illustrating a menu screen 220 based on the second embodiment.

FIG. 12 is a diagram illustrating a menu screen 230 based on the second embodiment.

FIG. 13 is a diagram illustrating a menu screen 240 based on the second embodiment.

FIG. 14 is a diagram illustrating a menu screen 250 based on the second embodiment.

FIG. 15 is a diagram illustrating a menu screen 260 based on the second embodiment.

FIG. 16 is a flowchart illustrating overview of reset processing in game device 1 based on the second embodiment.

FIG. 17 is a flowchart illustrating menu screen representation processing based on the second embodiment.

FIG. 18 is a flowchart illustrating list screen representation processing based on the second embodiment.

### DETAILED DESCRIPTION OF NON-LIMITING EXAMPLE EMBODIMENTS

This embodiment will be described in detail with reference to the drawings. The same or corresponding elements in the drawings have the same reference characters allotted and description thereof will not be repeated.

An information processing apparatus in the present embodiment may be a portable (also referred to as mobile) device such as a portable game device, a portable telephone, or a smartphone, a stationary device such as a personal computer or a home game console, or a large apparatus such as an arcade game machine. In the present example, a game device representing one example of an information processing apparatus will be described by way of example.

### First Embodiment

### Configuration of Game Device

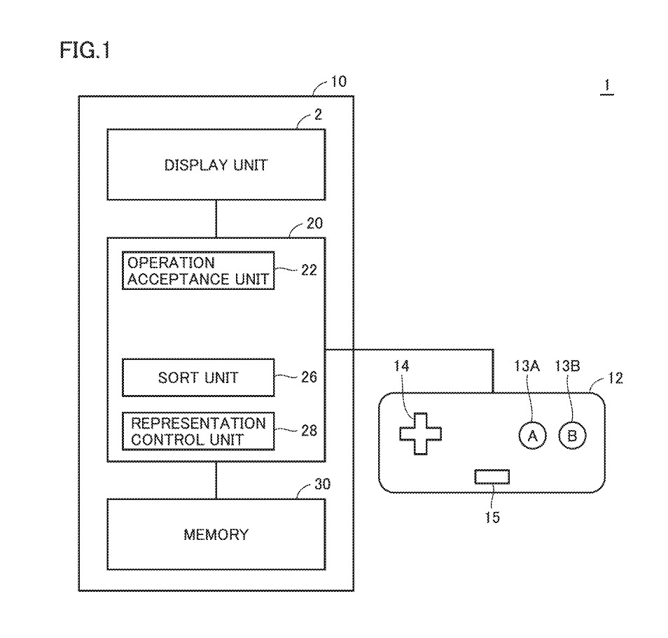

FIG. 1 is a schematic block diagram of a configuration of a game device 1 based on a first embodiment.

As shown in FIG. 1, game device 1 includes a game device main body 10 and a console 12.

Game device main body 10 includes a display unit 2, a CPU 20, and a memory 30.

CPU 20 is an information processing unit for performing various types of information processing performed in game device 1. CPU 20 performs the various types of information processing with the use of memory 30. Memory 30 stores various programs (including a game program and a main body program) executed in game device 1. Though an example where memory 30 is implemented by a storage unit contained in game device 1 will be described, it may be implemented, for example, by a storage medium which can be attached to or removed from game device 1 such as an optical disc or a cartridge, or both of the storage and the storage medium.

In the present embodiment, in game device 1, memory 30 stores two types of programs which are at least a game program and a main body program.

The game program may be, for example, a game program which reads game data and performs game processing by using the game data.

The main body program is a program for controlling a game program. It provides an interface screen for performing a prescribed operation on a game program.

CPU 20 implements various functional blocks based on the main body program stored in memory 30.

CPU 20 includes an operation acceptance unit 22, a sort unit 26, and a representation control unit 28.

Operation acceptance unit 22 accepts a prescribed operation from console 12.

Sort unit 26 sets an order of arrangement of a plurality of contents (icons). Sort unit 26 changes an order of arrangement of the plurality of contents (icons) in accordance with input of a prescribed operation through console 12 accepted by operation acceptance unit 22. By way of example of a content, in the present example, a game icon (also simply referred to as an icon) will be described. A game icon is an icon with which a corresponding game program can be executed as a result of selection thereof.

Representation control unit 28 has display unit 2 show a plurality of contents (icons) set or changed by sort unit 26. Representation control unit 28 has display unit 2 show information showing the changed order of arrangement.

Display unit 2 shows an image generated as a result of information processing by representation control unit 28.

Console 12 accepts an operation instruction given by a user such as an input through a button or a key.

An operation instruction accepted in console 12 is output to CPU 20.

Console 12 includes a cross-shaped key 14, an A button 13A, a B button 13B, and a select (SELECT) button 15 as input apparatuses.

Game device 1 may be implemented by a plurality of apparatuses. For example, game device 1 may be implemented by a main body apparatus having CPU 20 and an apparatus having console 12 and/or display unit 2, which are separate from each other. For example, in another embodiment, game device 1 may be implemented by a main body apparatus and a game device having console 12 and display unit 2, or by a main body apparatus and an operation apparatus having console 12. Game device 1 may employ a television as a display apparatus, without including display unit 2.

<List Configuration of Game Program>

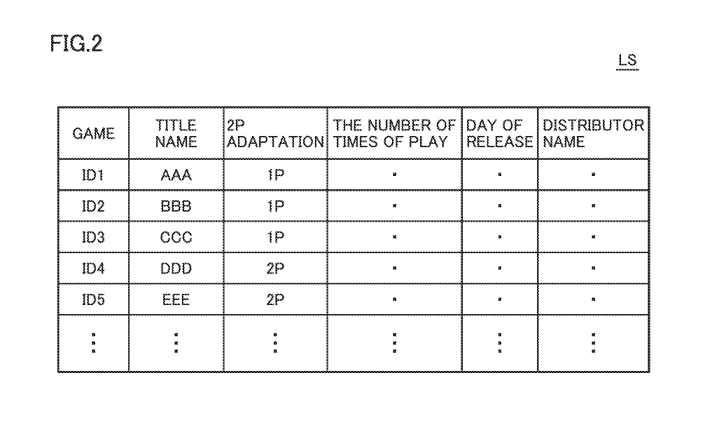

FIG. 2 is a diagram illustrating a list LS of game programs stored in memory 30.

As shown in FIG. 2, attribute information of a plurality of game programs is registered in advance as list LS in memory 30.

A game ID is allocated to each game program. A “title name,” “2P adaptation,” “the number of times of play,” a “day of release,” and a “distributor name” are registered in association with each game ID.

In the present example, a “title name” “AAA” is registered in correspondence with a game ID1, a “title name” “BBB” is registered in correspondence with a game ID2, a “title name” “CCC” is registered in correspondence with a game ID3, a “title name” “DDD” is registered in correspondence with a game ID4, and a “title name” “EEE” is registered in correspondence with a game ID5.

“1P”, “1P”, and “1P” in connection with an item “2P adaptation” are registered in correspondence with game ID1, game ID2, and game ID3, respectively. “2P” and “2P” in connection with the item “2P adaptation” are registered in correspondence with game ID4 and game ID5, respectively. In connection with the item “2P adaptation,” “2P” means that a game can be played by one player and by two players. “1P” means that a game can be played only by one player.

In list items in the present example, “the number of times of play” refers to a value showing the number of times of execution of a game program and it is updated any time in accordance with execution of the game program. Data on the “day of release” and the “distributor name” is registered in advance, and items other than “the number of times of play” are not updated or they may be updated.

<Description of Scheme of Order of Arrangement>

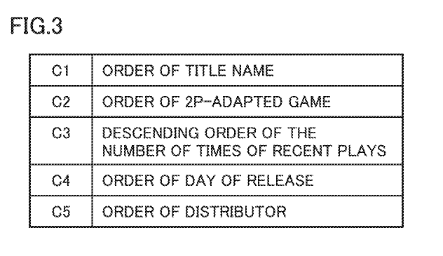

FIG. 3 is a diagram illustrating a list of schemes of an order of arrangement.

As shown in FIG. 3, a plurality of schemes of an order of arrangement are provided.

Specifically, a scheme of an order of arrangement including an “order of title name,” an “order of 2P-adapted game,” an “order of the number of times of recent plays,” an “order of day of release, and an “order of distributor” in correspondence with identifiers C1 to C5 is shown.

The “order of title name” refers to a scheme for setting an order of arrangement, for example, in accordance with priority of a character at the top. Specifically, icons are arranged in the order of priority from “A” to “Z”.

The “order of 2P-adapted game” means a scheme for setting an order of arrangement with priority of a game of “2P adaptation (a game can be played by two players)” being set to be high. Specifically, icons are arranged in the order of priority of “2P adaptation” and “1P adaptation.”

The “order of the number of times of recent plays” is a scheme for setting an order of arrangement with priority of a game greater in value for the number of counted times of execution of a game program being set to be high. Specifically, icons are arranged in the descending order of values for the number of times.

The “order of day of release” is a scheme for setting an order of arrangement with priority of a game of which day of release is more recent being set to be high. Specifically, icons are arranged in the order of proximity to the current date.

The “order of distributor” is a scheme for setting an order of arrangement in accordance with priority of the top character of a name of a distributor. Specifically, icons are arranged in the order of priority from “A” to “Z”.

A plurality of schemes of an order of arrangement may be combined without being limited to a single scheme of an order of arrangement.

The main body program includes a program executing a scheme of an order of arrangement. Though five schemes of an order of arrangement are described in the present example, more schemes of an order of arrangement can also be executed without being particularly limited thereto.

<Menu Screen>

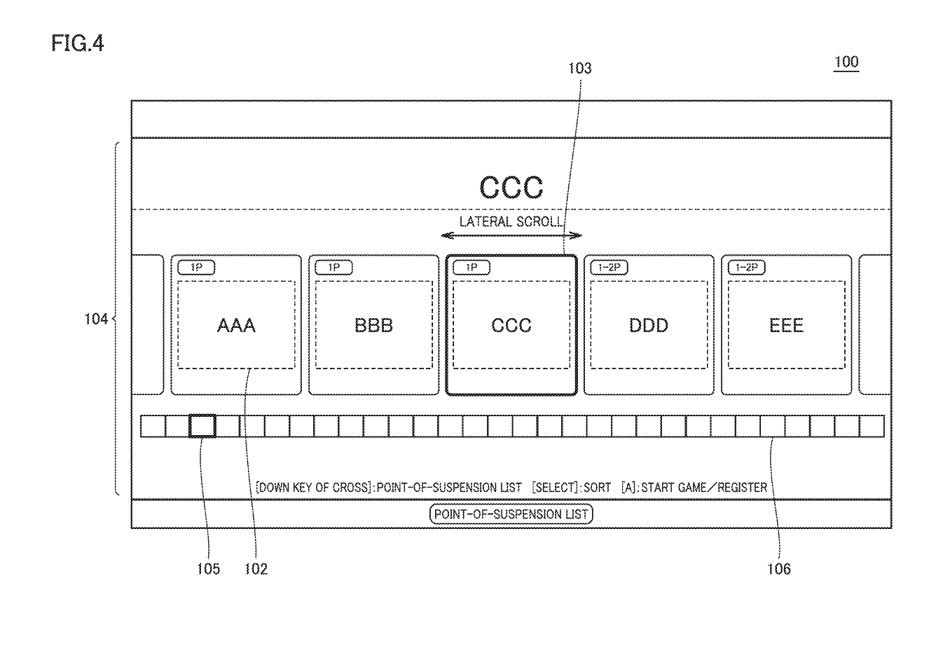

FIG. 4 is a diagram illustrating a menu screen 100 based on the first embodiment.

As shown in FIG. 4, menu screen 100 includes a game title list 104.

Some of a plurality of icons 102 corresponding to a plurality of game programs, respectively, are provided in game title list 104. In the present example, by way of example, five icons 102 are provided in game title list 104.

In the present example, a plurality of icons are laterally arranged in accordance with a prescribed order of arrangement. In an initial state, the “order of title name” is selected as a prescribed order of arrangement and arrangement is in accordance with that order of arrangement.

Therefore, icons 102 of game programs corresponding to the respective title names of “AAA”, “BBB”, “CCC”, “DDD”, and “EEE” are sequentially arranged and shown based on list LS of the game programs.

In the present example, by way of example, a plurality of icons 102 corresponding to the plurality of game programs, respectively, are arranged in the descending order of priority from the left to the right.

A selection cursor 103 is provided for one of the plurality of icons. Selection cursor 103 can be moved in the lateral direction (lateral scrolling) in accordance with an instruction to operate a left or right key of cross-shaped key 14 in console 12. In the present example, selection cursor 103 is located at icon 102 of a game program corresponding to the title name “CCC” (in a selected state).

When selection cursor 103 is located at icon 102 at the right end of the screen, icon 102 moves to the left in accordance with an instruction to operate the right key of cross-shaped key 14 in console 12, and next icon 102 and selection cursor 103 are shown as being superimposed on each other. An icon to follow the last icon of the plurality of icons arranged in accordance with the prescribed order of arrangement is arranged in such an endless manner that that icon is in turn defined as the top icon. Since an instruction to operate the left key of cross-shaped key 14 in console 12 is also the same in scheme, detailed description thereof will not be repeated.

In game title list 104, a list 106 of a plurality of thumbnail images corresponding to a plurality of game programs, respectively, is linearly provided under the plurality of icons 102. There are thumbnail images as many as the game programs. One thumbnail image in list 106 of the plurality of thumbnail images is shown, with an highlight frame 105 corresponding to a position of a thumbnail image corresponding to selection cursor 103 being added. Thus, to how manieth game program icon 102 selected by selection cursor 103 corresponds in the order of arrangement of the plurality of game programs as a whole can readily be known.

A point-of-suspension list which will be described later is further shown in accordance with a prescribed instruction to operate (a down key of) cross-shaped key 14 in console 12.

In the present example, select button 15 in console 12 is allocated as a button for an operation for change in arrangement. Sort processing is performed in accordance with an instruction to operate select button 15 in console 12. Each time select button 15 in console 12 is pressed, a plurality of orders of arrangement are successively selected and sort processing is repeatedly performed.

Execution (launch) of a game program corresponding to selection cursor 103 is indicated by an instruction to operate A button 13A in console 12 and the game program is executed (launched). A point-of-suspension icon is registered in a slot in accordance with an instruction to operate A button 13A in console 12, although description will be given later.

<Sort Screen>

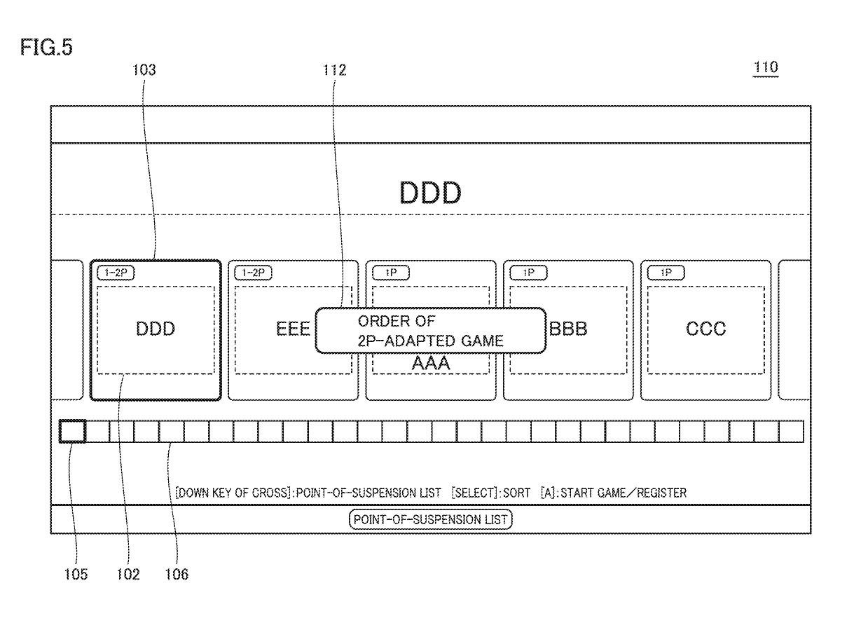

FIG. 5 is a diagram illustrating a menu screen 110 after sort processing based on the first embodiment.

As shown in FIG. 5, as compared with menu screen 100, menu screen 110 shows information 112 showing contents of sort processing. Information 112 showing the contents of sort processing is shown as being superimposed on a plurality of icons 102. In the present example, the “order of 2P-adapted game” is shown. Games are arranged in the descending order of priority of the “2P-adapted game.”

Therefore, based on list LS of game programs, icons 102 of game programs corresponding to the title names “DDD”, “EEE”, “AAA”, “BBB”, and “CCC”, respectively, are sequentially arranged and shown.

Information 112 showing the contents of sort processing is unshown after lapse of a prescribed period since sort processing in accordance with an instruction to operate select button 15 in console 12.

Selection cursor 103 is arranged at a position corresponding to top icon 102 of the plurality of arranged icons 102 after sort processing. Therefore, highlight frame 105 is provided and shown at a position of a thumbnail image at the top position in list 106 of the plurality of thumbnail images.

<Flow Processing>

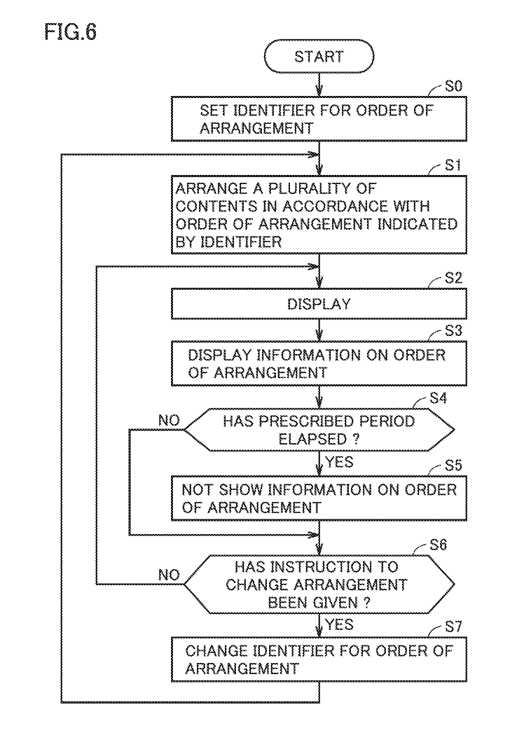

FIG. 6 is a diagram illustrating a flow of sort processing in game device 1 based on the first embodiment.

Processing is mainly performed by CPU 20.

As shown in FIG. 6, CPU 20 sets an identifier for an order of arrangement (step S0). Specifically, sort unit 26 sets an identifier “C1” as an initial state of the identifier for the order of arrangement.

Then, CPU 20 arranges a plurality of contents (icons) in accordance with the set identifier for the order of arrangement (step S1). Based on list LS, sort unit 26 arranges the plurality of contents (icons) based on the order of arrangement which is the “order of title name” in accordance with identifier C1 for the order of arrangement.

Then, CPU 20 has the plurality of arranged contents (icons) shown (step S2). Representation control unit 28 has display unit 2 show some of the plurality of contents (icons) in the order of title name arranged based on list LS by sort unit 26 as game title list 104 as described with reference to FIG. 4. Representation control unit 28 has list 106 of the plurality of thumbnail images corresponding to the plurality of game programs, respectively, shown as game title list 104 as described with reference to FIG. 4.

Then, CPU 20 has information showing contents of the order of arrangement shown in accordance with the identifier (step S3). Representation control unit 28 has information 112 on the “order of title name” shown as being superimposed on the plurality of icons 102 in accordance with identifier C1 for the order of arrangement as in FIG. 5.

Then, CPU 20 determines whether or not a prescribed period has elapsed (step S4). Representation control unit 28 determines whether or not information showing the contents of the order of arrangement has been shown for a prescribed period.

When CPU 20 determines that the prescribed period has elapsed (YES in step S4), it has the information showing the contents of the order of arrangement unshown (step S5). When representation control unit 28 determines that the information showing the contents of the order of arrangement has been shown for a prescribed period, it has the information showing the contents of the order of arrangement unshown. When representation control unit 28 has information 112 unshown, it may do so by having representation of information 112 fading out.

When CPU 20 determines that the prescribed period has not elapsed (NO in step S4), step S5 is skipped and the process proceeds to step S6.

Then, CPU 20 determines whether or not an instruction to change arrangement has been given (step S6). Specifically, operation acceptance unit 22 determines whether or not an instruction to operate select button 15 in console 12 has been given.

When CPU 20 determines in step S6 that an instruction to change arrangement has not been given (NO in step S6), the process returns to step S2, representation of the plurality of arranged contents is maintained and the processing above is repeated.

When CPU 20 determines in step S6 that the instruction to change the arrangement has been given (YES in step S6), it changes the identifier for the order of arrangement (step S7). Specifically, when operation acceptance unit 22 determines that an instruction to operate select button 15 in console 12 has been given, it notifies sort unit 26 of that fact. Sort unit 26 changes the identifier for the order of arrangement in accordance with the notification from operation acceptance unit 22. For example, identifier C1 is changed to identifier C2. The identifier is changed sequentially from C1 to C2, C3, C4, C5, and C1 each time an instruction to operate select button 15 in console 12 is given. After last identifier C5, the identifier returns to first identifier C1. Subsequent processing is the same.

Then, the process returns to step S1 and CPU 20 arranges the plurality of contents in accordance with the changed identifier for the order of arrangement. Based on list LS, sort unit 26 arranges the plurality of contents (icons) based on the order of arrangement which is the “order of 2P-adapted games” in accordance with identifier C2 for the order of arrangement.

In step S2, CPU 20 has the plurality of arranged contents (icons) shown. Representation control unit 28 has display unit 2 show some of the plurality of contents (icons) in the order of 2P adaptation arranged by sort unit 26 as game title list 104 as described with reference to FIG. 5. Representation control unit 28 has list 106 of the plurality of thumbnail images corresponding to the plurality of game programs, respectively, shown as game title list 104 as described with reference to FIG. 5. In step S3, CPU 20 has information showing contents of the order of arrangement shown in accordance with the identifier. Representation control unit 28 has information 112 on the “order of 2P-adapted game” shown as being superimposed on the plurality of icons 102 in accordance with identifier C2 for the order of arrangement as described with reference to FIG. 5. Representation control unit 28 has information 112 unshown after lapse of a prescribed period since an instruction to operate select button 15 in console 12 was given.

Since subsequent processing is the same, detailed description thereof will not be repeated.

In the present example, the order of arrangement can be changed with a simplified scheme in accordance with an instruction to operate select button 15 in console 12. When the order of arrangement is changed, information showing contents of the order of arrangement is shown for a prescribed period and is unshown after lapse of the prescribed period. Therefore, when the order of arrangement is changed, how the changed order of arrangement is can readily be known. Since the information is unshown after lapse of a prescribed period, interference by such a representation does not occur, and change to the order of arrangement as preferred by a user can be made with a simplified scheme.

Though change in order of arrangement of game icons (also simply referred to as icons) by way of example of a content has been described in the present example, limitation thereto is not intended, and an order of arrangement of a plurality of icons with which a plurality of commands are executed may be changed. Such change in order of arrangement is also similarly applicable to change in order of arrangement of data in a table or a list representing contents.

### Second Embodiment

Information processing when reset processing is performed in a game device will be described in a second embodiment.

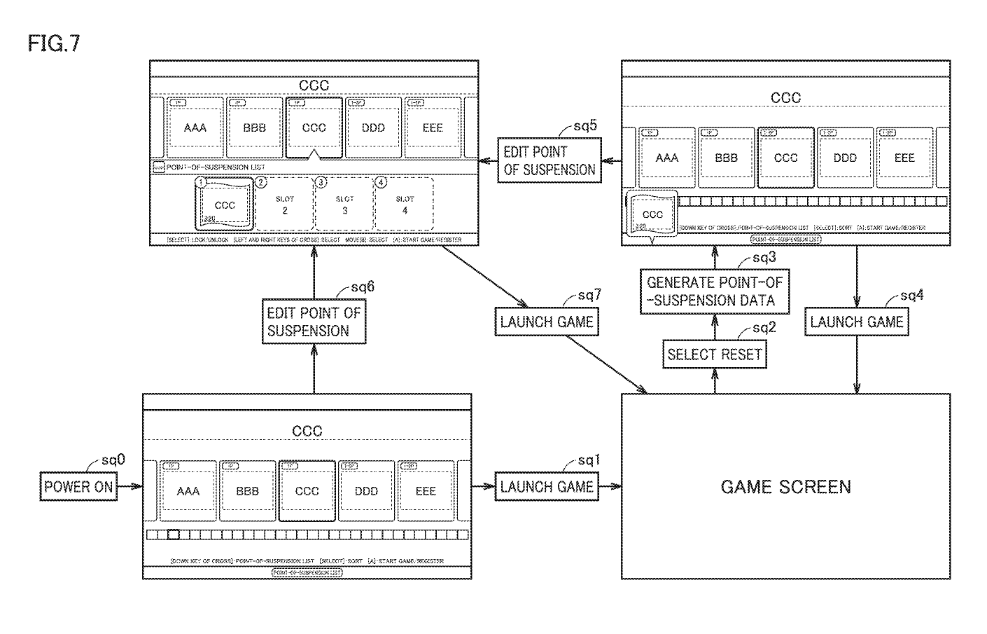

FIG. 7 is a diagram illustrating a concept of transition of a screen in a game device based on the second embodiment.

As shown in FIG. 7, a game device shows a menu screen as power is turned on (sequence sq0). The game device shows a game screen when an icon corresponding to a game program is selected in the menu screen and the game is launched (sequence sq1).

When a reset button is selected during game processing (sequence sq2), the game device suspends the game processing and generates point-of-suspension data (sequence sq3). The point-of-suspension data refers to backup data with which resumption of or return to the game can be made from the suspended state of the game processing. The game device then shows a menu screen including an point-of-suspension icon. When an icon corresponding to the game program is selected in the menu screen and the game is launched (sequence sq4), the game device shows the game screen.

When edition of the point of suspension in the menu screen including the point-of-suspension icon is indicated (sequence sq5), the game device shows a menu screen including a point-of-suspension list screen.

When edition of the point-of-suspension in the menu screen is indicated (sequence sq6), the game device shows the point-of-suspension list screen. When an icon corresponding to the game program is selected in the menu screen including the point-of-suspension list screen and the game is launched (sequence sq7), the game device shows the game screen.

When a game in the menu screen is launched, normally, icon 102 in game title list 104 is selected. When the game program corresponding to the icon is launched, a screen for having a user select whether or not to start the game after the title is shown, the number of players, and a difficulty level is shown, and the game is started after selection. Therefore, time and efforts to some extent have been required until the game is started.

For example, when point-of-suspension data based on reset processing immediately after start of the game is prepared, the game can immediately be started from the point-of-suspension data, the number of players or the difficulty level does not have to be set either, and the game can immediately be started without spending time and efforts.

The processing will specifically be described below.

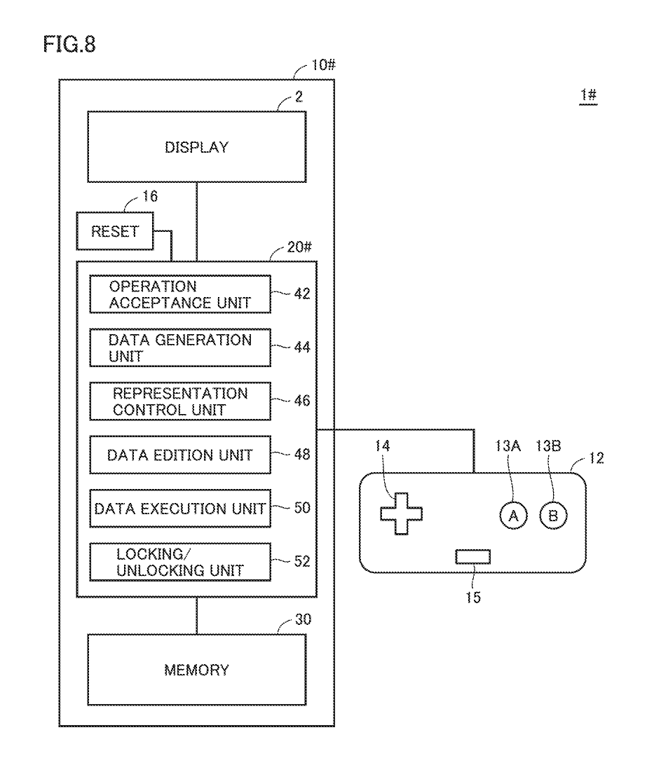

FIG. 8 is a schematic block diagram of a configuration of a game device 1# based on the second embodiment.

As shown in FIG. 8, game device 1# includes a game device main body 10# and console 12.

Game device main body 10# is different from game device main body 10 in that CPU 20 is replaced with a CPU 20# and it further includes a reset button 16.

CPU 20# implements various functional blocks based on a main body program stored in memory 30.

CPU 20# includes an operation acceptance unit 42, a data generation unit 44, a representation control unit 46, a data edition unit 48, a data execution unit 50, and a locking/unlocking unit 52.

Operation acceptance unit 42 accepts an operation from console 12 and reset button 16.

Data generation unit 44 generates point-of-suspension data in accordance with an instruction from reset button 16 accepted by operation acceptance unit 42.

Representation control unit 46 controls various representations on a menu screen on display unit 2.

Data edition unit 48 performs such processing as registration and edition of point-of-suspension data.

Data execution unit 50 performs execution of a game program.

Locking/unlocking unit 52 performs processing for locking (prohibiting edition of) or unlocking point-of-suspension data.

<Menu Screen>

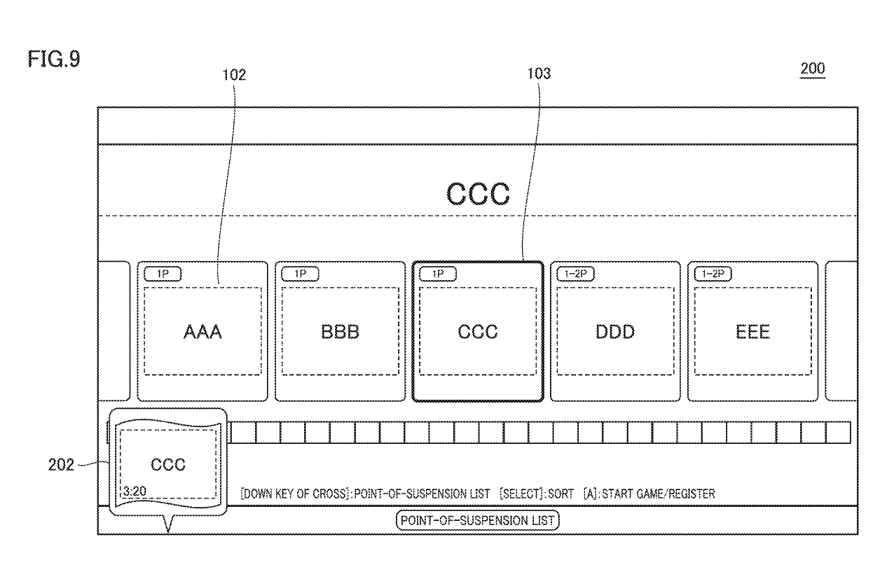

FIG. 9 is a diagram illustrating a menu screen 200 based on the second embodiment.

As shown in FIG. 9, as compared with menu screen 100, menu screen 200 further includes a point-of-suspension icon 202. Point-of-suspension icon 202 is based on point-of-suspension data. When reset button 16 is selected during game processing, the game processing is suspended. When suspension processing of the game processing is performed, CPU 20# automatically generates point-of-suspension data (backup data) with which resumption of the game from the suspended position or return to the game can be made. Then, point-of-suspension icon 202 is shown in accordance with the generated point-of-suspension data. By way of example, game processing of a game program having the title name “CCC” is suspended and point-of-suspension icon 202 of the game program having the title name “CCC” is provided.

Point-of-suspension icon 202 has not yet been registered and it is shown in a form indicating that fact. For example, the icon may be shown in such an animated representation as floating and being unstable. For example, when icon 102 is selected and an instruction to launch a game is given before the icon is registered, the point-of-suspension data is erased. Processing for launching the game program based on the point-of-suspension data may be performed from that state in accordance with a prescribed instruction.

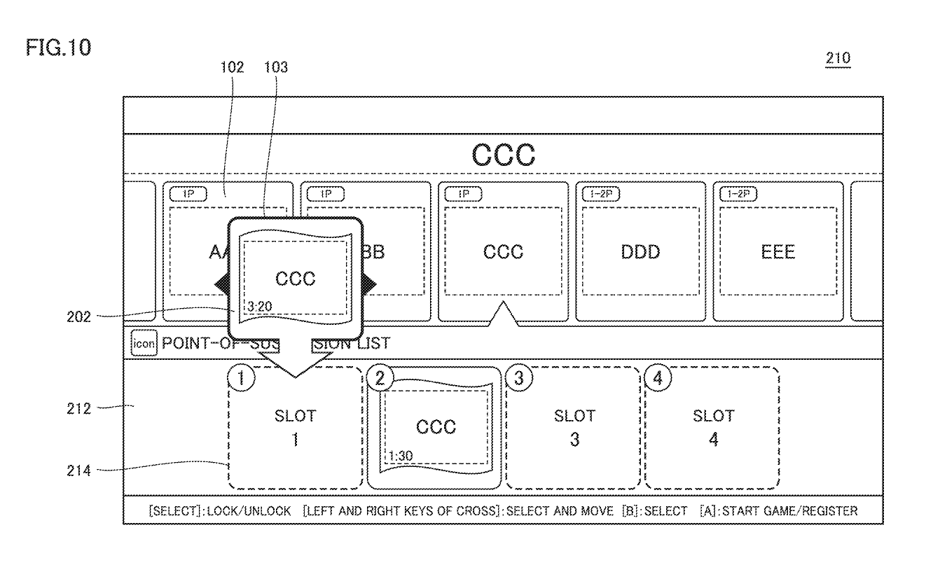

FIG. 10 is a diagram illustrating a menu screen 210 based on the second embodiment.

As shown in FIG. 10, as compared with menu screen 200, menu screen 210 further shows a point-of-suspension list screen 212.

Point-of-suspension list screen 212 is a screen in which a list of point-of-suspension data is shown and the point-of-suspension data can be edited. Point-of-suspension list screen 212 is prepared for each of icons 102 of the plurality of game titles. In menu screen 200, by setting any icon 102 in a selected state (a state that selection cursor 103 is superimposed thereon), point-of-suspension list screen 212 corresponding to icon 102 is shown in accordance with a prescribed instruction to operate (the down key of) cross-shaped key 14 in console 12.

By way of example, point-of-suspension list screen 212 includes four slots (storage areas) 214. Point-of-suspension data can be stored in each slot 214.

Point-of-suspension data is stored in second slot 214.

Point-of-suspension icon 202 is in a selected state (in a state that selection cursor 103 is superimposed thereon). In this case, point-of-suspension icon 202 is shown to be located above point-of-suspension list screen 212.

Point-of-suspension icon 202 can be stored in each slot. By setting point-of-suspension icon 202 in a selected state (a state that selection cursor 103 is superimposed thereon), point-of-suspension icon 202 can be moved over an empty slot of four slots 214 in accordance with an instruction to operate the left or right key of cross-shaped key 14 in console 12 (moved to a position over slot 214).

By selecting an instruction to operate A button 13A in console 12 in that state, point-of-suspension icon 202 can be stored (registered) in empty slot 214.

Without being limited to empty slot 214, point-of-suspension icon 202 can be stored also in slot 214 in which an icon has already been stored (overwriting).

For example, by moving point-of-suspension icon 202 to a position over second slot 214 and selecting an instruction to operate A button 13A in console 12, point-of-suspension icon 202 can also be stored in second slot 214 (overwriting).

In order to prevent an erroneous overwriting operation, a screen for checking an overwriting instruction may be shown. In order to prevent an erroneous operation, point-of-suspension icon 202 can also be stored in second slot 214 (overwriting) in accordance with an operation instruction for pressing and holding (selection for a prescribed period or longer) A button 13A in console 12. Alternatively, point-of-suspension data stored in slot 214 and point-of-suspension data indicated by point-of-suspension icon 202 selected with selection cursor 103 may be exchanged. As a result of exchange, data is not erased. If an erroneous operation is performed, it is also easy to return to the original state by making exchange again.

By setting point-of-suspension icon 202 to a selected state (a state that selection cursor 103 is superimposed thereon) and giving a prescribed instruction to operate console 12 (for example, selecting select button 15), a game program making use of the point-of-suspension data may be executed.

When an instruction to launch a game is given before storage (registration) of point-of-suspension icon 202 in slot 214, the point-of-suspension data is erased. When an instruction to launch a game is given before storage in slot 214 in the present example, point-of-suspension data is erased, however, it does not have to be erased.

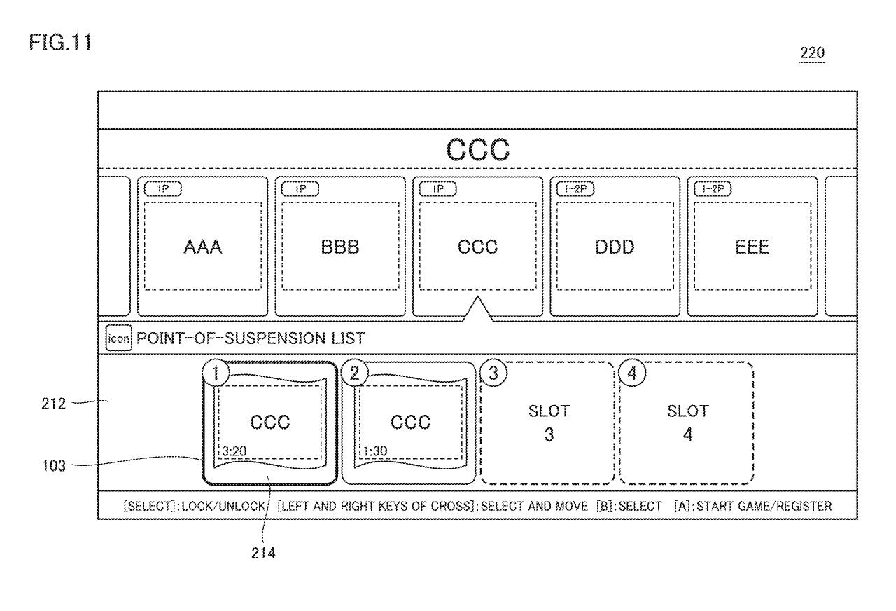

FIG. 11 is a diagram illustrating a menu screen 220 based on the second embodiment.

FIG. 11 shows menu screen 220 in which an instruction to operate A button 13A in console 12 is selected while point-of-suspension icon 202 in menu screen 210 has been selected. Accordingly, in menu screen 220, point-of-suspension data corresponding to point-of-suspension icon 202 is stored (registered) in first slot 214 in point-of-suspension list screen 212.

Point-of-suspension data has been stored also in second slot 214.

By moving selection cursor 103 over slot 214 and selecting A button 13A, processing for launching the game program making use of the point-of-suspension data is performed. Time representation is given to the point-of-suspension icon stored in the slot, and for example, “3:20” means point-of-suspension data of which reset processing was performed at the time when game processing was performed for 3 minutes and 20 seconds. “1:30” means point-of-suspension data of which reset processing was performed at the time when game processing was performed for 1 minute and 30 seconds. Owing to such time representation, which point-of-suspension data is made use of by a user can readily be identified and selected.

As a result of processing for launching a game program making use of point-of-suspension data, the game program can be resumed from the point (position) where reset processing was performed.

When a prescribed instruction to operate (an up key of) cross-shaped key 14 in console 12 is given, selection cursor 103 is moved to icons 102 of a plurality of game titles as described with reference to FIG. 9 and representation of point-of-suspension list screen 212 ends.

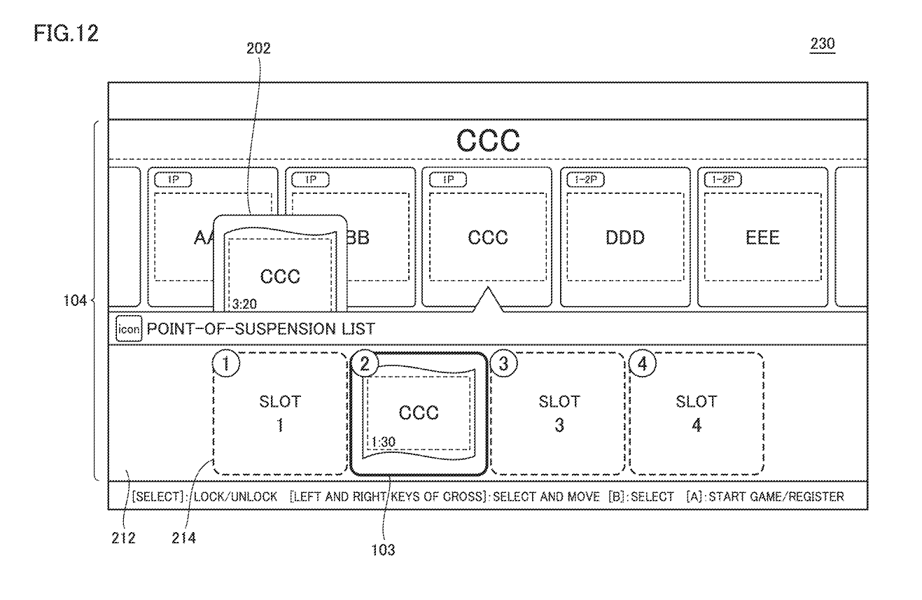

FIG. 12 is a diagram illustrating a menu screen 230 based on the second embodiment.

As shown in FIG. 12, menu screen 230 shows a state that selection cursor 103 is superimposed on second slot 214 as a result of an instruction to operate cross-shaped key 14 in console 12 in point-of-suspension list screen 212.

For example, in menu screen 210, in accordance with an instruction to operate the down key of cross-shaped key 14 in console 12, selection cursor 103 moves to point-of-suspension list screen 212. Then, selection cursor 103 can be superimposed on second slot 214 as a result of an instruction to operate the right key of cross-shaped key 14 in console 12.

In this case, no selection cursor is superimposed on point-of-suspension icon 202. In this case, point-of-suspension icon 202 is shown to be located behind point-of-suspension list screen 212. Therefore, as point-of-suspension icon 202 is shown at a position behind point-of-suspension list screen 212, a state that point-of-suspension icon 202 is not selected can be shown as being emphasized. Such a representation is by way of example, and an emphasized representation may be provided by animation.

By moving selection cursor 103 over point-of-suspension data stored in each slot in point-of-suspension list screen 212 and selecting B button 13B, the point-of-suspension data can be set to the selected state so that processing such as edition can be performed. For example, when selection cursor 103 is moved over point-of-suspension data stored in second slot 214, B button 13B is pressed, selection cursor 103 is moved to a position of fourth slot 214 in accordance with an instruction to operate the right key of cross-shaped key 14 in console 12, and B button 13B is pressed again, point-of-suspension data stored in second slot 214 can be moved to fourth slot 214.

When a prescribed instruction to operate (the up key of) cross-shaped key 14 in console 12 is given with point-of-suspension icon 202 being located as in menu screen 230, selection cursor 103 is superimposed on point-of-suspension icon 202 again as shown in FIG. 10. Then, representation of point-of-suspension list screen 212 ends in accordance with a prescribed instruction to operate (the up key of) cross-shaped key 14 in console 12 and menu screen 200 described with reference to FIG. 9 is shown.

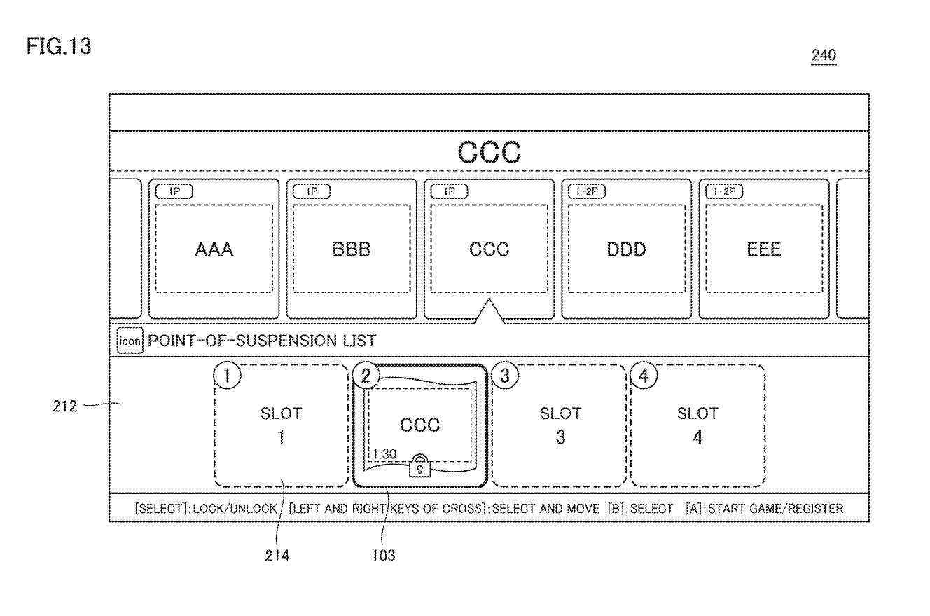

FIG. 13 is a diagram illustrating a menu screen 240 based on the second embodiment.

As shown in FIG. 13, menu screen 240 shows that second slot 214 has been locked.

When selection cursor 103 is moved and select button 15 is selected while point-of-suspension data is stored in slot 214, the point-of-suspension data is locked (edition thereof is prohibited). In the present example, a lock icon is added. When selection cursor 103 is moved over the locked point-of-suspension data and select button 15 is selected, the point-of-suspension data is unlocked. When locked, edition (erase) of the point-of-suspension data in slot 214 is prohibited. Edition (overwriting) of slot 214 is also prohibited.

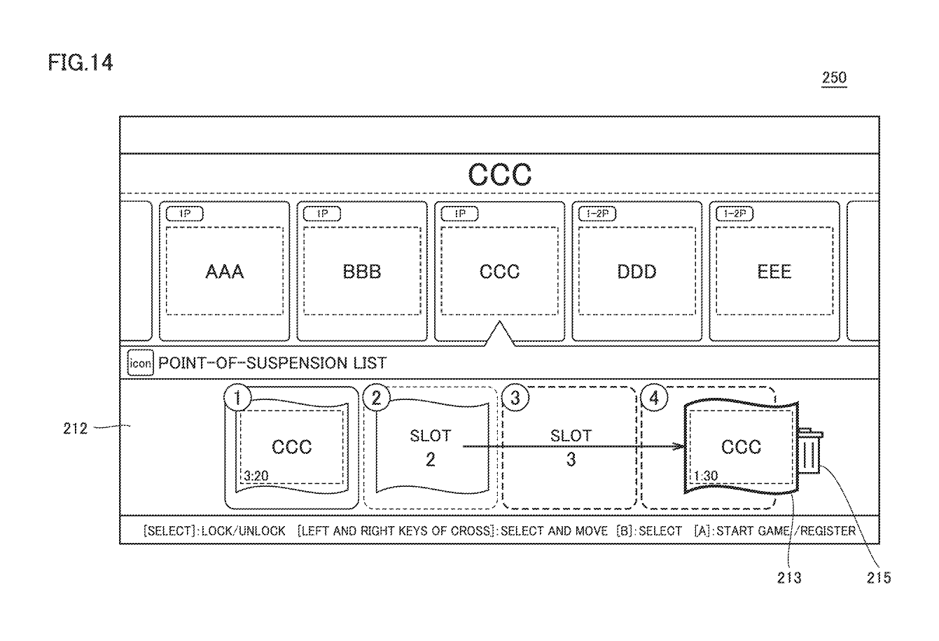

FIG. 14 is a diagram illustrating a menu screen 250 based on the second embodiment.

As shown in FIG. 14, in point-of-suspension list screen 212, point-of-suspension data stored in second slot 214 is erased. A trash box icon 215 is provided on the right in point-of-suspension list screen 212. Point-of-suspension data can be erased by performing an operation to hold a point-of-suspension icon 213 by moving selection cursor 103 over slot 214 and pressing B button 13B, moving held point-of-suspension icon 213 to a position of trash box icon 215 in accordance with a prescribed instruction to operate (the right key of) cross-shaped key 14 while B button 13B is pressed, and releasing B button 13B while point-of-suspension icon 213 is located over trash box icon 215. Trash box icon 215 may be shown only during a period in which B button 13B is pressed.

Point-of-suspension icon 213 can also be stored in first slot 214 (overwriting) by moving selection cursor 103 over point-of-suspension data stored in second slot 214, selecting the point-of-suspension data by pressing B button 13B in console 12, moving point-of-suspension icon 213 to a position over first slot 214, and pressing again B button 13B in console 12. As described above, in order to prevent an erroneous overwriting operation, a screen for checking an overwriting instruction may be shown. In order to prevent an erroneous operation, point-of-suspension icon 213 can be stored in first slot 214 (overwriting) by giving an operation instruction for pressing and holding (selection for a prescribed period or longer) B button 13B in console 12. Alternatively, point-of-suspension data stored in first slot 214 and point-of-suspension data indicated by point-of-suspension icon 213 (point-of-suspension data stored in second slot 214) may be exchanged. As a result of exchange, data is not erased. If an erroneous operation is performed, it is also easy to return to the original state by making exchange again.

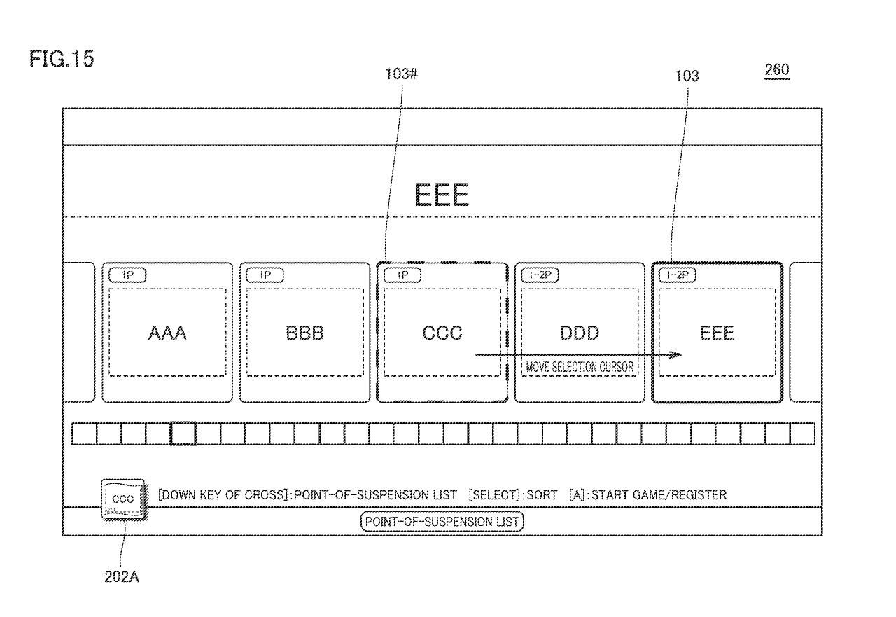

FIG. 15 is a diagram illustrating a menu screen 260 based on the second embodiment.

As shown in FIG. 15, as compared with menu screen 100, in menu screen 260, selection cursor 103 is moved in accordance with a prescribed instruction to operate (the left or right key of) cross-shaped key 14 in console 12. Specifically, selection cursor 103 is moved to icon 102 having the title name “EEE” from icon 102 having the title name “CCC”.

A point-of-suspension icon 202A corresponds to point-of-suspension data corresponding to a game program having the title name “CCC”. Therefore, since it is not associated with icon 102 having the title name “EEE”, point-of-suspension icon 202A is shown to be small in size in the present example.

In order to show in an emphasized manner that icon 102 is associated with point-of-suspension icon 202A, a sub cursor 103# is added to icon 102 having the title name “CCC”. As sub cursor 103# is added, which is icon 102 corresponding to point-of-suspension icon 202A can readily be identified. Sub cursor 103# and selection cursor 103 may be distinguished from each other by varying a shape or a color.

Such a representation is by way of example, and various representations may be given by animation.

When selection cursor 103 is moved to icon 102 different from icon 102 having the title name “CCC”, an operation instruction to return to icon 102 to which sub cursor 103# has been added can also be given by operating cross-shaped key 14 in console 12. Alternatively, however, a short-cut function may be used. For example, selection cursor 103 may return to a position of icon 102 to which sub cursor 103# has been added in response to an instruction to select B button 13B in console 12. Thus, selection cursor 103 can be moved over icon 102 corresponding to point-of-suspension icon 202A with a simplified operation.

<Flow Processing>

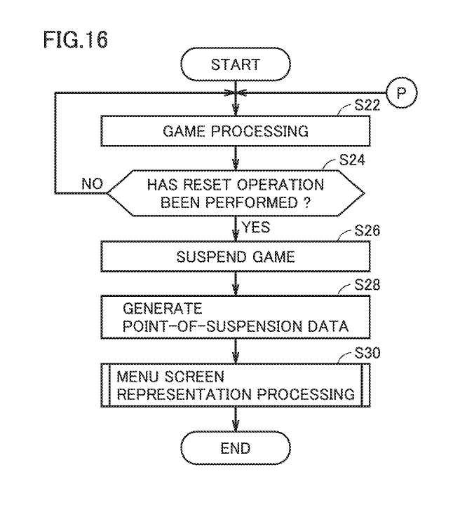

FIG. 16 is a flowchart illustrating overview of reset processing in game device 1# based on the second embodiment.

Processing is mainly performed by CPU 20#.

As shown in FIG. 16, CPU 20# performs game processing (step S22). Specifically, data execution unit 50 performs game processing based on a launched game program. By way of example, a game program having the title name “CCC” is launched.

Then, CPU 20# determines whether or not a reset operation has been performed (step S24).

Specifically, operation acceptance unit 42 determines whether or not reset button 16 has been selected (operated).

When CPU 20# determines that a reset operation has not been performed (NO in step S24), the process returns to step S22 and the processing above is repeated.

When CPU 20# determines that a reset operation has been performed (YES in step S24), it suspends the game (step S26). Specifically, when operation acceptance unit 42 determines that reset button 16 has been selected, it gives an instruction to data execution unit 50. Accordingly, data execution unit 50 suspends the game processing.

Then, CPU 20# generates point-of-suspension data (step S28). Specifically, data execution unit 50 gives an instruction to data generation unit 44 and data generation unit 44 generates point-of-suspension data with which game processing can be resumed at a position of suspension.

Then, CPU 20# performs menu screen representation processing (step S30). Details of the menu screen representation processing will be described later.

Then, the process ends (end).

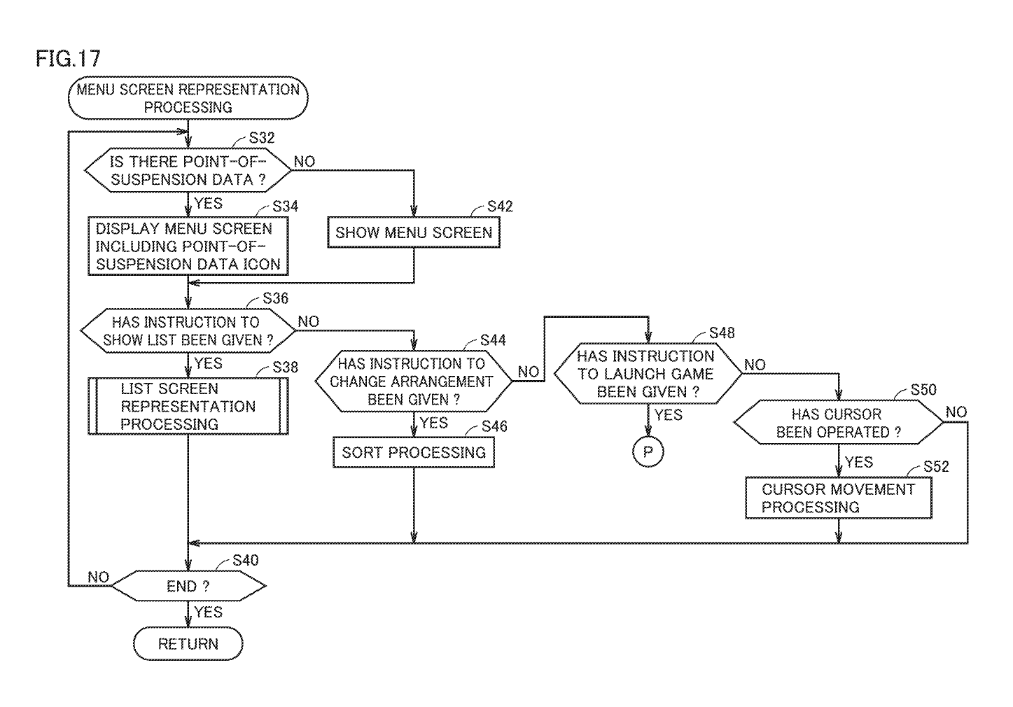

FIG. 17 is a flowchart illustrating menu screen representation processing based on the second embodiment.

As shown in FIG. 17, CPU 20# determines whether or not there is point-of-suspension data (step S32). Representation control unit 46 determines whether or not there is point-of-suspension data generated by data generation unit 44.

When CPU 20# determines that there is point-of-suspension data (YES in step S32), it has a menu screen including a point-of-suspension icon shown (step S34). When representation control unit 46 determines that there is point-of-suspension data generated by data generation unit 44 as described with reference to FIG. 9, it has a menu screen including a point-of-suspension icon shown.

When CPU 20# determines that there is no point-of-suspension data (NO in step S32), it has a normal menu screen shown (step S42).

Then, CPU 20# determines whether or not an instruction to show a list of point-of-suspension data has been given (step S36). Specifically, operation acceptance unit 42 sets any icon 102 of a plurality of game titles in the menu screen to a selected state and determines whether or not an instruction to operate the down key of cross-shaped key 14 in console 12 has been accepted.

When CPU 20# determines in step S36 that an instruction to show a list of point-of-suspension data has been given (YES in step S36), it performs list screen representation processing (step S38). Representation control unit 46 has the list screen shown in accordance with an instruction from operation acceptance unit 42. Details of the list screen representation processing will be described later.

Then, CPU 20# determines whether or not the process has ended (step S40).

When CPU 20# determines in step S40 that the process has ended (YES in step S40), the process ends (return.

When CPU 20# determines in step S40 that the process has not ended (NO in step S40), the process returns to step S32 and the processing above is repeated.

When CPU 20# determines that an instruction to show a list of point-of-suspension data has not been given (NO in step S36), it determines whether or not an instruction to change arrangement has been given (step S44). Specifically, operation acceptance unit 42 determines whether or not selection of select button 15 in console 12 has been accepted.

When CPU 20# determines in step S44 that an instruction to change arrangement has been given (YES in step S44), it performs sort processing. Specifically, the processing described in the first embodiment is performed. Then, the process proceeds to step S40.

When CPU 20# determines in step S44 that an instruction to change arrangement has not been given (NO in step S44), it determines whether or not an instruction to launch a game has been given (step S48). Specifically, operation acceptance unit 42 determines whether or not selection of A button 13A in console 12 has been accepted while selection cursor 103 is superimposed on icon 102.

When CPU 20# determines in step S48 that an instruction to launch a game has been given (YES in step S48), the process proceeds to “P” and to step S22 in FIG. 16. In response to an instruction from operation acceptance unit 42, data execution unit 50 launches a game program corresponding to selected icon 102 and performs game processing. Subsequent processing is the same.

When CPU 20# determines in step S48 that an instruction to launch a game has not been given (NO in step S48), it determines whether or not a cursor has been operated (step S50). Specifically, operation acceptance unit 42 determines whether or not an instruction to operate the left or right key of cross-shaped key 14 has been accepted.

When CPU 20# determines in step S50 that the cursor has been operated (YES in step S50), it performs processing for moving the cursor (step S52). In accordance with an instruction from operation acceptance unit 42 (an instruction to operate the left or right key of cross-shaped key 14), representation control unit 46 moves selection cursor 103.

Then, the process proceeds to step S40.

When CPU 20# determines in step S50 that the cursor has not been operated (NO in step S50), the process proceeds to step S40.

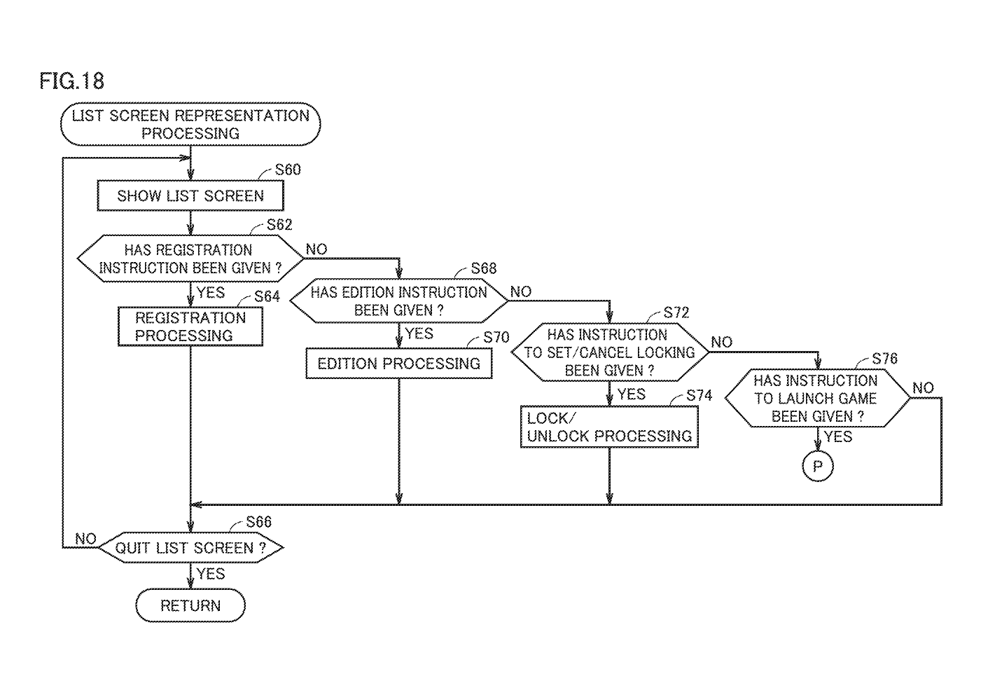

FIG. 18 is a flowchart illustrating list screen representation processing based on the second embodiment.

As shown in FIG. 18, CPU 20# performs processing for showing a point-of-suspension list screen (step S60). Specifically, representation control unit 46 additionally shows point-of-suspension list screen 212 as described with reference to FIG. 10.

Then, CPU 20# determines whether or not a registration instruction has been given (step S62). Specifically, as described with reference to FIG. 10, when point-of-suspension icon 202 has been selected, operation acceptance unit 42 determines whether or not an instruction to operate A button 13A in console 12 has been accepted.

When CPU 20# determines in step S62 that a registration instruction has been given (YES in step S62), it performs registration processing (step S64). Specifically, when operation acceptance unit 42 has accepted an instruction to operate A button 13A in console 12, it determines that a registration instruction has been given and gives an instruction to data edition unit 48. Data edition unit 48 performs processing for storing point-of-suspension data in slot 214 as described with reference to FIG. 11.

Then, CPU 20# determines whether or not a list screen has ended (step S66). CPU 20# determines whether or not it has given an instruction to quit processing for showing the list screen. Specifically, operation acceptance unit 42 determines whether or not it has accepted a prescribed instruction to operate (the up key of) cross-shaped key 14 while selection cursor 103 is superimposed on slot 214 in point-of-suspension list screen 212. In this case, operation acceptance unit 42 gives an instruction to representation control unit 46 and representation control unit 46 quits representation of the point-of-suspension list screen.

When CPU 20# determines in step S66 that processing for showing the list screen has ended, the process ends (return).

When CPU 20# determines in step S66 that the processing has not ended (NO in step S66), the process returns to step S60.

When CPU 20# determines in step S62 that a registration instruction has not been given (NO in step S62), it determines whether or not an edition instruction has been given (step S68). Specifically, operation acceptance unit 42 determines whether or not it has accepted an instruction to operate B button 13B while selection cursor 103 is superimposed on slot 214 in point-of-suspension list screen 212.

When CPU 20# determines in step S68 that an edition instruction has been given (YES in step S68), it performs edition processing (step S70). Specifically, data edition unit 48 sets point-of-suspension data stored in slot 214 on which selection cursor 103 is superimposed to a selected state in response to an instruction from operation acceptance unit 42 and performs the edition processing. For example, as shown in FIG. 14, point-of-suspension data can be erased by moving point-of-suspension icon 213 over trash box icon 215. A position of point-of-suspension icon 213 can be changed by moving point-of-suspension icon 213 over empty slot 214. Data in slot 214 may be overwritten or replaced by moving point-of-suspension icon 213 over slot 214 in which point-of-suspension data has been stored.

Then, the process proceeds to step S66.

When CPU 20# determines in step S68 that an edition instruction has not been given (NO in step S68), it determines whether or not an instruction to set/cancel locking has been given (step S72). Specifically, operation acceptance unit 42 determines whether or not an instruction to operate select button 15 has been given while selection cursor 103 has been moved over slot 214 in which point-of-suspension data has been stored. When an instruction to operate select button 15 has been given, operation acceptance unit 42 determines that an instruction to set/cancel locking has been given and gives an instruction to locking/unlocking unit 52.

When CPU 20# determines in step S72 that an instruction to set/cancel locking has been given (YES in step S72), it performs locking/unlocking processing (step S74).

In response to an instruction from operation acceptance unit 42, locking/unlocking unit 52 locks the point-of-suspension data (prohibition of edition). As shown in FIG. 13, a state that a lock icon has been added is shown. When operation acceptance unit 42 accepts selection of select button 15 as a result of movement of selection cursor 103, locking/unlocking unit 52 unlocks the locked point-of-suspension data.

When locking/unlocking unit 52 locks the data, edition (erase) of the point-of-suspension data in slot 214 is prohibited. Edition (overwriting) of slot 214 is also prohibited. Then, the process proceeds to step S66.

When CPU 20# determines in step S72 that an instruction to set/cancel locking has not been given (NO in step S72), it determines whether or not an instruction to launch a game has been given (step S76). Operation acceptance unit 42 determines whether or not selection of A button 13A in console 12 has been accepted while selection cursor 103 is superimposed on slot 214 in point-of-suspension list screen 212.

When it is determined in step S76 that an instruction to launch a game has been given (YES in step S76), the process proceeds to “P” and to step S22 in FIG. 16. In response to the instruction from operation acceptance unit 42, data execution unit 50 launches a game program making use of point-of-suspension data corresponding to selected slot 214 and performs game processing. Subsequent processing is the same.

When it is determined in step S76 that an instruction to launch a game has not been given (NO in step S76), the process proceeds to step S66.

<Function and Effect>

A function and effect of the present embodiment will now be described.

An information processing program in the present embodiment is executed by CPU 20 of game device 1 connected to a display. The information processing program causes CPU 20 to function as operation acceptance unit 22 which accepts an operation of select button 15 in console 12, sort unit 26 which changes an order of arrangement of a plurality of contents (icons) in accordance with an operation of select button 15 in console 12 accepted by operation acceptance unit 22, and representation control unit 28 which has the display show the plurality of contents (icons) of which order of arrangement has been changed by sort unit 26. Representation control unit 28 has information 112 showing contents of the changed order of arrangement shown for a prescribed period. Therefore, when the order of arrangement is changed, how the order of arrangement is can readily be known and change to an order of arrangement preferred by a user can be made with a simplified scheme.

As shown in FIG. 5, representation control unit 28 has information 112 showing contents of the changed order of arrangement unshown after lapse of a prescribed period since an operation of select button 15 in console 12 accepted by operation acceptance unit 22. Since information 112 is unshown after lapse of a prescribed period, interference by the representation does not occur.

As shown in FIG. 5, representation control unit 28 has information showing contents of the changed order of arrangement shown for a prescribed period such that the information is superimposed on at least some of the plurality of contents (icons). By superimposing information 112 showing the contents of the order of arrangement on at least some of the plurality of contents (icons), a user can readily know contents of change in order of arrangement.

Sort unit 26 sequentially selects a plurality of types of order of arrangement in accordance with an operation of select button 15 in console 12 accepted by operation acceptance unit 22 and changes an order of arrangement of the plurality of contents (icons) in accordance with the selected order of arrangement. Since a plurality of orders of arrangement are sequentially selected in accordance with an operation of select button 15, the order of arrangement can be changed with a simplified scheme.

When input of an operation of select button 15 in console 12 is accepted by operation acceptance unit 22 after the last order of arrangement of the plurality of types of order of arrangement is selected, sort unit 26 selects the first order of arrangement of the plurality of types of order of arrangement. The order of arrangement can be changed with a simplified scheme from the last order of arrangement to the first order of arrangement in accordance with an operation of select button 15 in console 12.

As shown in FIG. 5, representation control unit 28 further has the display show selection cursor 103 with which each of the plurality of contents shown on the display can be selected in accordance with an instruction. Representation control unit 28 has selection cursor 103 shown in correspondence with the top content of the plurality of contents arranged by sort unit 26. Since representation control unit 28 has selection cursor 103 shown in correspondence with the top content (icon) of the plurality of contents (icons) arranged by sort unit 26, the top content (icon) after change in arrangement can readily be selected.

As shown in FIG. 4, a plurality of contents correspond to a plurality of icons in a menu, respectively. Therefore, convenience of a user can be improved by changing an order of arrangement of a plurality of icons to an order of arrangement as adapted to preference of a user.

Game device 1 in the present embodiment is connected to a display. Game device 1 includes operation acceptance unit 22 which accepts an operation of select button 15 in console 12, sort unit 26 which changes an order of arrangement of a plurality of contents (icons) in accordance with an operation of select button 15 in console 12 accepted by operation acceptance unit 22, and representation control unit 28 which has the display show the plurality of contents (icons) of which order of arrangement has been changed by sort unit 26. Representation control unit 28 has information 112 showing contents of the changed order of arrangement shown for a prescribed period. Therefore, when the order of arrangement is changed, how the order of arrangement is can readily be known and change to an order of arrangement preferred by a user can be made with a simplified scheme.

Game device 1 in the present embodiment is connected to a display. As shown in FIG. 6, game device 1 accepts an operation of select button 15 in console 12 in step S6, and changes an order of arrangement of a plurality of contents in accordance with the accepted input of select button 15 in console 12 in step S1. Game device 1 shows on the display, a plurality of contents of which order of arrangement has been changed in steps S2 and S3. Game device 1 shows information 112 showing contents of the changed order of arrangement for a prescribed period in steps S4 and S5. Therefore, when the order of arrangement is changed, how the order of arrangement is can readily be known and change to an order of arrangement preferred by a user can be made with a simplified scheme.

A game system in the present embodiment includes display unit 2, operation acceptance unit 22 which accepts an operation of select button 15 in console 12, sort unit 26 which changes an order of arrangement of a plurality of contents (icons) in accordance with an operation of select button 15 in console 12 accepted by operation acceptance unit 22, and representation control unit 28 which has the display show the plurality of contents (icons) of which order of arrangement has been changed by sort unit 26. Representation control unit 28 has information 112 showing contents of the changed order of arrangement shown for a prescribed period. Therefore, when the order of arrangement is changed, how the order of arrangement is can readily be known and change to an order of arrangement preferred by a user can be made with a simplified scheme.

An application executable by a personal computer may be provided as a program in the present embodiment. The program according to the present embodiment may be incorporated as some functions of various applications executed on the personal computer.

While certain example systems, methods, devices, and apparatuses have been described herein, it is to be understood that the appended claims are not to be limited to the systems, methods, devices, and apparatuses disclosed, but on the contrary, are intended to cover various modifications and equivalent arrangements included within the spirit and scope of the appended claims.

What is claimed is:

1. A non-transitory storage medium encoded with a computer readable information processing program executed by a computer of an information processing apparatus connected to a display, the information processing program causing the computer to function as:
an operation acceptance unit which accepts a prescribed operation;
a sort unit which changes an order of arrangement of a plurality of contents in accordance with input of the prescribed operation accepted by the operation acceptance unit; and
a representation control unit which has the display show the plurality of contents of which order of arrangement has been changed by the sort unit,
the representation control unit having information shown for a prescribed period, the information showing contents of the changed order of arrangement.

2. The non-transitory storage medium according to claim 1, wherein
the representation control unit has the information showing the contents of the changed order of arrangement unshown after lapse of the prescribed period since the prescribed operation accepted by the operation acceptance unit.

3. The non-transitory storage medium according to claim 1, wherein
the representation control unit has the information showing the contents of the changed order of arrangement shown for the prescribed period as being superimposed on at least some of the plurality of contents.

4. The non-transitory storage medium according to claim 1, wherein
the sort unit sequentially selects a plurality of types of order of arrangement in accordance with input of the prescribed operation accepted by the operation acceptance unit and changes the order of arrangement of the plurality of contents in accordance with the selected order of arrangement.

5. The non-transitory storage medium according to claim 4, wherein
the sort unit selects a first order of arrangement from among the plurality of types of order of arrangement when input of the prescribed operation is accepted by the operation acceptance unit after a last order of arrangement of the plurality of types of order of arrangement is selected.

6. The non-transitory storage medium according to claim 1, wherein
the representation control unit further has the display show a selection cursor with which each of the plurality of contents shown on the display can be selected in accordance with an instruction, and
the representation control unit has the selection cursor shown in correspondence with a first content of the plurality of contents arranged by the sort unit.

7. The non-transitory storage medium according to claim 1, wherein
the plurality of contents correspond to a plurality of icons in a menu, respectively.

8. An information processing apparatus connected to a display comprising:
an operation acceptance unit which accepts a prescribed operation;
a sort unit which changes an order of arrangement of a plurality of contents in accordance with input of the prescribed operation accepted by the operation acceptance unit; and
a representation control unit which has the display show the plurality of contents of which order of arrangement has been changed by the sort unit,
the representation control unit having information shown for a prescribed period, the information showing contents of the changed order of arrangement.

9. A method of controlling an information processing apparatus connected to a display comprising:
accepting a prescribed operation;
changing an order of arrangement of a plurality of contents in accordance with input of the accepted prescribed operation; and
showing on the display, the plurality of contents of which order of arrangement has been changed,
the showing the plurality of contents including showing information showing contents of the changed order of arrangement for a prescribed period.

10. An information processing system comprising:
a display unit;
an operation acceptance unit which accepts a prescribed operation;
a sort unit which changes an order of arrangement of a plurality of contents in accordance with input of the prescribed operation accepted by the operation acceptance unit; and
a representation control unit which has the display unit show the plurality of contents of which order of arrangement has been changed by the sort unit,
the representation control unit having information shown for a prescribed period, the information showing contents of the changed order of arrangement.
